(19) United States
(12) Patent Application Publication
(10) Pub. No.: US 2013/0060842 A1
(43) Pub. Date: Mar. 7, 2013

(54) REMOTE DESKTOP AND DATA MANAGEMENT SYSTEM

(71) Applicant: Fred GROSSMAN, Glen Rock, NJ (US)

(72) Inventor: Fred GROSSMAN, Glen Rock, NJ (US)

(73) Assignee: WORLD SOFTWARE CORPORATION, Glen Rock, NJ (US)

(21) Appl. No.: 13/589,987

(22) Filed: Aug. 20, 2012

Related U.S. Application Data
(60) Provisional application No. 61/525,820, filed on Aug. 21, 2011.

(51) Int. Cl. G06F 15/16

(52) U.S. Cl. 709/203

(57) ABSTRACT

The invention relates to systems and methods for facilitating interactions between client-based applications (e.g. SaaS applications) and a cloud-based data storage and management system comprising a terminal server, communication server, software agent, and a thin client. The terminal server provides remote desktop services to the client, including one or more published applications. The communication server may interact with the terminal server and the software agent, which may communicate with published applications on behalf of client-based applications. The software agent is able to facilitate communications between the client and the terminal server, via the communication server, as needed to give the impression that a published application runs locally at the client computer.

### CROSS-REFERENCE TO RELATED APPLICATION

This application claims the benefit of U.S. Provisional Patent Application No. 61/525,820, filed Aug. 21, 2011, the entire contents and substance of which are hereby incorporated by reference as if fully set forth below.

### TECHNICAL FIELD

The invention and its various embodiments relate in general to software as a service (SaaS) and to cloud computing. In particular, the invention relates to systems and methods for facilitating interactions between client-based applications (e.g. SaaS Applications) and a cloud-based data storage and management system.

### BACKGROUND

In many computing environments, networked users may need access to data on local or remote servers within the network at various locations, they may need to share or track data, and they may need access to the network and its applications and data from remote locations outside the network. Data, e.g. documents, files, or content, may be in various formats, corresponding to various software applications, such as word processing files, spreadsheet files, multimedia files, etc. Users may also need access to applications, and possibly associated hardware, regardless of whether each application is installed locally on a user's computer. Likewise, individual applications may need access to data of various users in various locations.

One approach to such distributed or enterprise computing environments is to store data remotely in a cloud-based system. In these systems, data can reside on remote servers “in the cloud,” and is delivered to users from those servers over a network, for example, a wide area network (WAN), a virtual private network (VPN), or via the interne. These networks may communicate with a local area network (LAN) in order to reach a user. The user interface for cloud computing may include a web browser, or an application that facilitates communication between the user and remote data. Such applications have been referred to as “thin” desktop applications or “thin clients.” Thin clients typically incorporate software programs to emulate desktop sessions, such as Microsoft RDP (Remote Desktop Protocol) or Citrix ICA (Independent Computing Architecture). Mobile applications can also be used. Cloud computing can be advantageous because it uses shared resources and management to provide efficiencies, flexibility, and coordinated administration across an enterprise.

Software applications (and associated data) can also be “published” to users from the cloud, e.g. by download, streaming, so-called “push” technologies, or by imaging a user-specific instance of an application that is running remotely on a user's computer. Broadly, software provisioned to users in a remote manner, rather than from a permanently installed local copy, can be called “software on demand” or “software as a service” (SaaS). Typically, each application and its data are hosted on servers in the cloud, accessible by a web browser or a thin client. Systems for publishing applications include Citrix® XenApp (or Presentation Server) and Citrix® Dazzle available from Citrix Systems, Inc.

In addition to providing access to applications and data for users, it may be necessary or desirable for an enterprise to manage and coordinate the applications and data throughout a network or for a group of users. For example, profiles, tags, and metadata may be associated with applications and data files, e.g. to categorize documents, provide for search and retrieval, determine and monitor user access, apply security policies, establish version control, track workflow, or otherwise administer applications and data for users. Information or document management systems, sometimes called content management systems, have been developed to provide this function. Generally, these systems associate applications and data (e.g. files, documents or any content) with each other and with other information in a database (e.g., an SQL database), and they provide various access and manipulation functions. One data or document management system (DMS) is Worldox®, available from World Software Corporation. Another DMS is iManage WorkSite, available from Autonomy Corporation, a subsidiary of Hewlett-Packard, Inc. A DMS is a software system or application, with associated data, which can be furnished to users locally or from the cloud.

All of the components or modules in a distributed or cloud-based SaaS model must communicate with each other, and must function together in a coordinated manner, even though many parameters and variables are involved, and regardless of the diverse locations, remote distances, and intervening networks that may be involved. One or more applications or software modules running on a user's computer or in a user session, whether “thin” or otherwise, will typically need to monitor and govern the integration of different applications and their communications with each other, as well as provide a user interface with the desired functionality and content. This is particularly important, and more complex, when one or more software applications are integrated with a DMS in a cloud-based architecture, to seamlessly provide each application and the DMS, together with all of their data, in a SaaS environment.

Another complicating factor is the operating system (OS), which also must communicate with and govern the interaction and/or behavior of applications running on a particular computer or within a particular desktop session. The processing and communications overhead required for this coordinated computing effort can be large and unwieldy, may interfere with a desirable and productive user experience, may be error prone, and has security implications for sensitive data. By analogy, there are many “moving parts” in such a system that must be accounted for, often in real time. Various embodiments of the invention provide solutions to these problems.

Remote desktop imaging software, or terminal emulation programs, such as Citrix® Receiver, Symantec's PC Anywhere™, or LogMeln®, can deliver an interactive image of a remote desktop or user session, running on a server or a local computer, to another computer or thin client at a remote location. These programs allow for convenient and relatively efficient user access to a session running elsewhere, including all of the software and data that is running and available from a particular computer or desktop session. However, if the remote session itself uses cloud computing or SaaS and incorporates a DMS, the underlying issues of coordinating the software within that session remain, including the communications traffic between various applications and their servers, the movement of data among the applications, the delivery, output and display of data to the user, the dynamic functionality of user input, and the ongoing manipulation of data by the user and by the integrated applications. Furthermore, terminal emulator or “thin client” systems may generally require large amounts of memory, computing resources, and bandwidth in order to maintain complete interactive desktop sessions on remote servers for each user in a network.

Technologies, such as Citrix® or Microsoft published applications, furnish an application from a server to a client. It would be desirable to utilize published applications to provide users with an integrated application and DMS system in a SaaS architecture. A single published application deployed with a DMS in this manner requires frequent communication with other applications on the local computer. This type of communication may be burdensome and slow across a cloud-based network, as opposed to communications between programs running locally on a single user computer, or across a high-speed LAN. Further, such application-to-application communications may be and typically are prohibited in a SaaS environment, because each single published application is running remotely on a server, under the control of a server-side OS, and is partitioned, e.g. by a firewall, from the desktop OS that is running locally for the user. Each published application also has limited access to memory and other hardware resources of the local computer. Thus, a published application may be “walled off” from other client applications, such as a DMS, from other modules, plug-ins, or the like that reside on the local computer or on another server, or from full communication with the client's operating system and the client's hardware and certain peripheral equipment, published instances of Microsoft Office, or other application software. Since the application cannot truly “see” the client desktop, it cannot achieve the desired integration and interaction with other applications in conventional designs.

Some efforts have been made to coordinate local applications and remote documents. Gauvin et al., U.S. Pat. No. 5,991,760, provides a downloader for downloading onto the client computer a copy of a remote network document (local copy) that is accessible by the local application program. When disconnected from the network, the local copy may be accessed and modified through the client browser in a manner that is similar to when the client is connected to the network. Gauvin ‘760 allows for updating a copy of a remote document stored in a local computer system, particularly to reflect changes made by the client computer during a disconnect from the network. In Gauvin et al., U.S. Pat. No. 6,061,686, the inventors describe a system for synchronizing remote and local copies of a document when changes are made by a user. These methods allow a user to continue working on a remote document without interruption during periods when a network connection is lost. However, the problem of coordinating multiple applications and documents in a SaaS model over a network, with integrated document management, is not addressed.

Klevenz, et al., U.S. Pat. No. 7,650,609, discloses a system and method for accessing a document management system in a multi-environment processing system, using a web-based protocol that can be accessed in common by multiple applications, even though the applications may run under different and generally incompatible platforms. Independent processing environments are disclosed, for a management or web service that executes document requests and translates commands, and for a client application environment that communicates with the management service. This approach may allow programs running on different platforms to understand each other, however, an orchestrated cloud or SaaS environment with document management is not provided.

Riviello et al, U.S. Publication No. 2010/0145904, discloses a network-based document management system that assists in the creation and formatting of complex documents, using so-called Passport files to maintain security and establish rules for document assembly and distribution.

Sikka, et al., U.S. Publication No. 2009-0172553, provides a system for translating the features and functionality of a spreadsheet into a software service, such as a web service. This system emulates a native spreadsheet application, converts native spreadsheet data into a form suitable for emulation, and delivers the result to a user, e.g. via a web browser.

These references do not suggest or describe systems or methods for integrating applications, data, document management, and corresponding operating systems for a client or user in a cloud-based or SaaS environment.

### BRIEF SUMMARY

Various embodiments of the invention are systems and methods for coordinating the communication, management, and use of separate but integrated applications and their data in a cloud-based or SaaS environment, particularly where the applications and data may reside locally, i.e., on a client computer, or may or run on servers at various remote locations.

It would be advantageous to achieve better application utilization by enabling published applications to have access to operating system (OS) resources, memory, and other hardware or software resources on a client computer or desktop session. Improved communication and integration could then be achieved between two or more published applications, or between one or more published applications and local application, including for example a user application and a DMS. It would also be desirable to enable a cloud-based or SaaS solution that would be both efficient and cost effective.

To better address one or more of these concerns, in one aspect of the invention, systems and methods for facilitating interaction of (1) a terminal emulator with (2) a cloud-based data management system and (3) a client-based or another cloud-based application are disclosed.

In one embodiment of the system, a thin client and a SaaS agent are installed on each client computer system. The thin client may be configured to establish and maintain a connection between the computer system, on which it is installed, and a shared terminal server running instances of terminal services. The SaaS agent may be configured to establish and maintain a connection between the computer system, on which it is installed, and a shared communication server providing cloud services, including access to document management services to support the local applications. In some embodiments, the SaaS agent may be integrated into the thin client, and the thin client may be tasked with managing connections to both the terminal server and the communication server. In some further embodiments, the terminal server and the communication server may be combined into a single server or may run at a shared remote location.

The terminal server and the communication server may be disposed in mutual communication to maintain mappings of the terminal services and local applications, to emulate co-location of the terminal services and local applications operating with disparate document management services. In this manner, quality-of-service and performance may be maintained between terminal emulated services and local applications utilizing document management services disparate to the terminal emulated services.

These and other objects, features, and advantages of the invention's various embodiments will become more apparent upon reading the following specification in conjunction with the accompanying drawing figures.

### BRIEF DESCRIPTION OF THE DRAWINGS

FIG. 1 is a diagram of a data management system for facilitating interactions between a terminal emulator, local applications, and published applications, according to some embodiments of the invention.

FIG. 2 is a flowchart of a process to initiate and maintain communication between a local software agent, a remote communication server, a remote DMS, and a local or published user application, according to some embodiments of the invention.

FIG. 3 is a flowchart showing initiation of a file open or save process using the remote DMS, according to some embodiments of the invention.

FIG. 4 is a flowchart of the file open process, according to some embodiments of the invention.

FIG. 5 is a flowchart of the file save process, according to some embodiments of the invention.

FIG. 6 is a diagram of a computer system useable with some embodiments of the invention.

### DETAILED DESCRIPTION

Various embodiments of the present invention are systems and methods for cloud-based data management. The systems and methods may be implemented in various ways. For example, and without limitation, the data management systems and methods may be embodied in a computer system or a computer program product. If implemented in a computer program product, various aspects of the systems and methods may be embodied in computer-readable instructions for execution by a processor.

The components described as making up various elements of the invention are intended to be illustrative and not restrictive. Many suitable components that would perform the same or similar functions as components described herein are intended to be embraced within the scope of the data management systems and methods. Such other components may include, for example, and without limitation, components that are developed after this invention.

Various embodiments of the invention include data management systems and methods for providing seamless interaction capabilities between local applications at a client computer, published applications, and a DMS that is a published application.

Terms used in this specification have their ordinary meaning in the field, particularly the field of computer science and software engineering. Specific terms may be used herein according to the following definitions.

“Cloud computing” or “cloud-based” refers to the delivery of computing storage or software applications to client computers located remotely from the computing storage or software applications.

“Software as a service” or (SaaS) refers to software that is cloud-based and provided to a client computer on-demand.

“Document management system” (DMS) refers to a set of one or more software applications configured to manage electronic documents.

“Remote” means located or taking place across a network from another device. The device may be any device, resource or action, including without limitation a computer or computing device, a peripheral device, or any hardware or software comprising or residing in a computing device. The network can be any network, including without limitation the internet. “Remote” may be considered the opposite of “local.”

“Local” means located or taking place in a particular device. The device may be any device, resource or action, including without limitation a computer or computing device, a peripheral device, or any hardware or software comprising or residing in a computing device. “Local” may be considered the opposite of “remote.”

“Application” refers to computer software that is generally provided for a specific task or set of tasks.

“Published application” means an application that is provided or installed at one or more locations or servers, and which is accessible as a cloud-based application from one or more client computers. Each client computer typically, but not necessarily, can be considered a local machine that is remote from at least one of these locations or servers.

“Server” refers to a computing device or computer software that responds to requests from other computing devices or computer software.

“Client” means a computing device or computer software that requests data or services from a server.

“Thin client” refers to a computing device or computer software that depends on another computing device or computer software to accomplish one or more tasks.

Referring now to the figures, in which like reference numerals represent like parts, various data management systems and method according to embodiments of the invention will be described in detail.

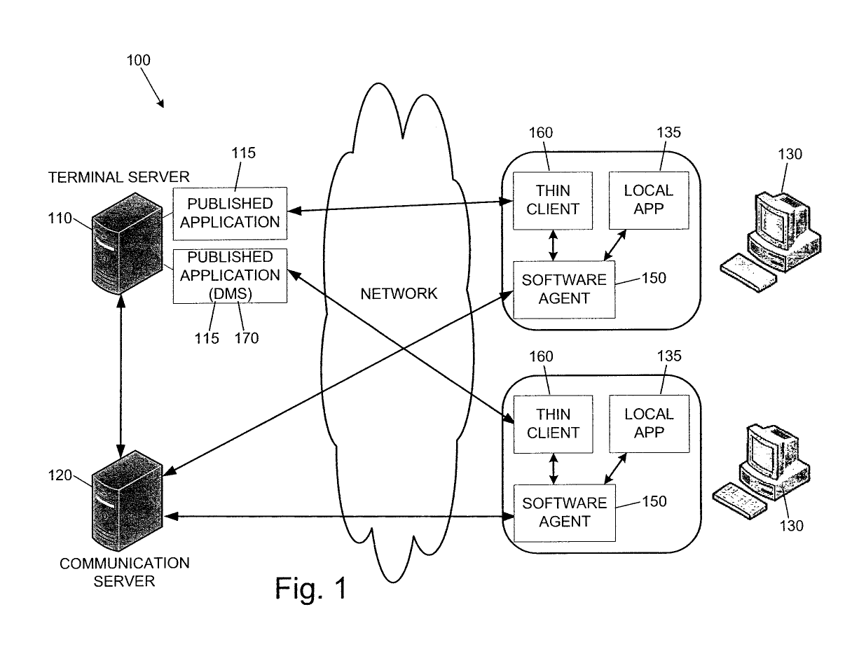

FIG. 1 illustrates a data management system 100, according to an exemplary embodiment of the invention. As shown, the data management system 100 may comprise a terminal server 110, a communication server 120, and one or more components on each of a plurality of client computers 130 located remotely from the servers 110 and 120. More specifically, the data management system 100 may include a software agent 150, also referred to herein as a “SaaS agent,” and one or more thin clients 160 installed or otherwise running on each client computer 130. With these components, the data management system 100 may facilitate interactions of a terminal emulator, i.e., the thin client 160, provided at the client computer 130, with a cloud-based data management system and local or published applications 115 and 135.

The terminal server 110 and communication server 120 may be co-located, such as at a private data center, and each disposed in independent communication with the client computers 130 over a network, such as the internet. Alternatively, the terminal server 110 and the communication server 120 may be combined into a single server.

One or more published applications 115 may be installed on the terminal server 110, so as to be accessible as cloud-based applications by the plurality of client computers 130. The terminal server 110 may embody and execute remote desktop services enabling execution of the published applications 115 through the client computers 130. The published applications 115 may then be accessible from the client computers 130, through the thin clients 160. Each thin client 160 may be a web browser or other application that requires little hard drive space for installation but is configured to display content received from the terminal server 110. Each thin client 160 may be associated with a published application 115 on the terminal server 110, and may access the terminal server's remote desktop services to behave as a terminal emulator, providing access to the published applications 115 to a user at the client computer 130. In an exemplary embodiment, a client computer 130 may have one thin client 160 for each published application 115 that it accesses.

In an exemplary embodiment, the terminal server 110 may also be in communication with the thin client 160, for example by implementing a desktop emulator, such as RDP or ICA. This communication path can be thought of as a first or direct path between the thin client 160 and the terminal server 110. The software agent 150 and the terminal server 110 may also interact with each other via the communication server 120, which provides an additional communication path. This can be thought of as a second or indirect path, e.g., for instructions and responses (input/output), between published applications 115 and the client computer 130 in some instances. A dual or multiple path architecture of this kind provides advantages and capabilities that improve upon the features and functions of a conventional direct or single communication path, e.g. between a thin client 160 (and local or client computer 130) and a published application 115 (hosted on a terminal server 110). For example, in operation the software agent 150 may monitor the thin client 160 and its communications with terminal server 110 and/or a published application 115 (e.g. by monitoring a direct communication path and/or a local communication path within client computer 130). The software agent 150 may also monitor each published application 115 and its communication with terminal server 110 and/or a thin client 160 (e.g. by monitoring an indirect communication path and/or a remote communication path within terminal server 110). Software agent 150 may also monitor one or more local applications 135 on client computer 130, as well as communications involving the local application 135, e.g. communications with the thin client 160. Likewise software agent 150 may monitor one or more instances or sessions of each operating system associated with any of a client computer 130, a local application 135, a thin client 160, a published application 115 and a terminal server 110, as well as monitoring communications between any of them, and the state of any software or hardware residing on or accessible to client computer 130 or terminal server 110, or accessible to a local application 135, a thin client 160, or a published application 115.

Software agent 150 may react or take action in connection with any monitoring activity, including for example responding to any communication, input, output, event, instruction, operation, or result that it monitors. Different embodiments of the invention, and of the software agent 150 particularly, may selectively monitor and selectively respond to different actions and in different ways. In a preferred embodiment, the software agent 150 is selectively capable of monitoring, intercepting and replacing communications or instructions between any of a local application 135, a thin client 160, a client computer 130, a published application 115, a terminal server 110, and any operating system associated with any of them. As one example, software agent 150 may monitor a local application for file open and file save instructions. When a file open or save instruction occurs, the software agent may intercept the instruction and/or the response to the instruction, for example by substituting a file open or file save procedure of a published application (e.g. a DMS) for that of the local application. This can be accomplished, for example, by communicating with terminal server 110 and published application 115 via communications server 120 (a second or indirect path), such that a thin client instance of a published application is able to communicate and interact with a local application, in a manner which may not be available directly (e.g. from published application to terminal server to thin client and then from thin client to local application). In this way, the software agent 150 can function as a gatekeeper or mediator, to selectively intervene and provide seamless integration of local and remote applications.

The terminal server 110 may uniquely identify each communication session with a thin client 160, so as to distinguish communications with one thin client 160 from communications with another thin client 160 at the same or a different client computer 130. For example, and without limitation, when communication is initiated between a thin client 160 and the terminal server 110, the terminal server 110 may issue a session identifier to identify that particular conversation, i.e., a series of data exchanges, with that thin client 160. Processes running on the terminal server 110 associated with that session may be tagged with the session identifier, to distinguish them from other processes related to other thin clients 160. In some embodiments, the session identifier may be transmitted back to the thin client 160. When transmitting a communication to the terminal server 110, the thin client 160 may include its current session identifier to assist the terminal server 110 in distinguishing the communication from communications received from other thin clients 160.

Conventionally, a published application 115 would not have access to various operations of the operating system, as security would disallow such access. Various embodiments of the present invention, however, can overcome this issue and allow the same access, or similar access, to the operating system as is generally given to local applications 135.

The software agent 150 on the client computer 130 may designate the remote published application as a local application to the operating system of the local or client computer. In other words, the software agent 150 may “fool” the operating system of the client computer 130 into thinking that a remote, published application 115 (such as a remote DMS 170) is installed locally. In brief, the software agent 150 may create or initiate the thin client 160, which may be a stub or scaled-down version of an associated published application 115, when access to the associated published application 115 is desired. Because the thin client 160 is installed locally on the client computer 130, the thin client 160 may communicate with the operating system of the client computer 130. The thin client 160 may thus send input to and receive output from the operating system and local applications 135. In this way, the thin client can “masquerade” as a local instance of a published application.

In addition, the software agent 150 may be configured to monitor and distinguish between two or more instances of an operating system (OS) running on the same client computer 130, for example where a first OS is running locally and a second or multiple instances of another OS are each running remotely (e.g., on the terminal server 110), as sessions of, or in communication with, the same computer 130. Each OS may be the same or different. For example, a local or published application 115 or 135 running on a computer 130, or in a thin client session, may require access to a local OS, such as Microsoft Windows, to perform certain functions, such as printing a document. The application may require access to a remote OS, such as Linux or another instance of Windows, e.g., to access information from a remote database that integrates with the application, such as a DMS 170. In another example, an application such as Microsoft Word may access the local OS for backing up open documents locally, and may access a remote OS to open or save a document in concert with a remote DMS 170. The software agent 150 may dynamically manage which instance of which OS has foreground focus during a process or application function, so that all operations can proceed smoothly and seamlessly for the user, as experienced via the thin client 160, browser, or other interface. This may be accomplished by an interrupt process that matches application requests and OS calls to the correct identifier on the terminal server 110, and the correct published application 115 and OS, via communications between the software agent 150 and the terminal server 110, typically mediated by the communication server 120.

The thin client 160 and the software agent 150 may work together to provide remote access to the published application 115 associated with the thin client 160. The operating system may communicate with the thin client 160, which may communicate with the software agent 150, which may communicate with the communication server 120. Because of this communication, the communication server 120 may be able to access the operating system in a manner similar to that generally granted to a local application 135. Further, the communication server 120 and the terminal server may be in communication with each other to coordinate in providing the published application 115 to the thin client 160, so that the published application 115 may run with indirect access to the operating system. For example, keystrokes received at the thin client 160 and communicated to the terminal server 110 would then be interpreted by the terminal server 110 in the context of the associated published application 115.

In some embodiments, the thin client 160 may be a small software application that establishes and maintains a connection between a client computer 130 and the terminal server 110. The thin client 160 may transmit all, or a selected subset of, input from the client computer's user to the terminal server 110. This input may include, for example, keystrokes and mouse movements. The thin client 160 may also display information and print streams received from the terminal server 110. The data management system 100 may thus provide an effective and reliable way to distribute published applications 115, providing a single point of installation with multiple users, where the users may run programs and use network resources as if the user were sitting in front of the terminal server 110.

In some embodiments, local applications 135 at the client computer 130 may require access to one or more published applications 115. For example, and without limitation, a local application 135 (e.g., Microsoft® Word) may request a document managed by the DMS 170 running as a published application on the communication server 120. The data management system 100 may provide such access given the configuration of components described above.

In some embodiments, the software agent 150 may be a small software application that establishes and maintains the connection between a local application 135 installed on the client computer 130 and a DMS 170 or other published application 115 running on the terminal server 110. Each instance of the software agent 150 may transmit all, or a subset of, data requests relative to the DMS 170 or other published application 115 to the communication server 120. Output from the communication server 120, such as documents and data files received from the DMS 170 on the terminal server 110, may be relayed through the software agent 150 to the desired destination on the client computer 130. Thus, the software agent 150 and the communication server 120 may provide cloud services for local applications 135.

The software agent 150 may accelerate the handling of dialog box initiating activities in a local application 135, such as save and open, with respect to documents in the DMS 170. When a user of the client computer 130 attempts to save or open a file from the DMS 170, the software agent 150 may cause a dialog box to pop-up on the screen. This pop-up box, also called a “soft pop-up,” may be populated by the communication server 120 with the appropriate DMS details. In some implementations, in which a local application 135 attempts to access a document on the DMS 170, if the user attempts to click back into the local application 135, the dialog box provided by the software agent 150 may maintain its position in the foreground. As a result, the user may be required to click through one or more foreground or superseding dialog boxes in order to access the requested document. This can provide an effective and reliable way to distribute a DMS 170 and ensure not only a high quality-of-service level, but maintenance of the integrity of the DMS 170. For example, by substituting native application dialogs with a DMS dialog, the DMS may retain control of opening, saving, and logging each document, and can accurately update and maintain its databases.

The software agent 150 may be aware of, or may have access to, all published applications 115 available at the communication server 120. The local application 135 may request access to a document on the DMS 170 from the software agent 150. In turn, the software agent 150 may communicate with the communication server 120 to retrieve the document and, as needed, update the document when changes are made from the local application 135. If the local application 135 requests write access to the document, the software agent 150 may request that the DMS 170 lock the document, so that write access not allowed to multiple client computers 130 simultaneously.

In the above scenario, the local application 135 would be capable of natively displaying the document and, as needed, providing interaction-capability to the user at the client computer 130. The local application 135 would thus not need to go through a thin client 160 to use the DMS 170 the way it might go through the thin client 160 to use various other published applications 115. In other words, unlike published applications 115 for which the thin client 160 plays a role, use of the DMS 170 in this instance may not require a terminal emulator, since the DMS 170 need only deliver one or more documents to the requesting local applications 135. The DMS 170 itself need not appear to run on the client computer 130. In contrast, if a published application 115 requested access to a document managed by the DMS 170, then the thin client 160 may be used to facilitate interactions between the user and the published application 115 requesting the access the document.

In some cases, local applications 135 and published applications 115 may need to communicate with each other to accomplish a task. It is not uncommon for local applications on a single computer to communicate with each other, and the data management system 100 may enable this type of seamless communication between local applications 135 and published applications 115, as if both were installed on the client computer 130. To this end, the communication server 120 may have a listening functionality installed thereon. Upon a unique identifier being established by the terminal server 110 for a communication session with a thin client 160 associated with the published application 115, the communication server 120 may establish an agent identifier to represent a unique session at the communication server 120. The session identifier and the agent identifier may be associated with each other, for example by way of a common mapping, so that two-way communications may flow between, on one side, the local applications 135 (which may be accessing documents from the DMS 170) and, on the other side, the published applications 115, as if the local and published applications were each installed locally.

In some embodiments, when the DMS 170 is accessed through the software agent 150 at the client computer 130, the communication server 120 may send a message to the terminal server 110 informing the terminal server 110 of the identity of the associated client computer 130 for the session. Analogously, when a local application 135 is started, the local application 135 informs the terminal server 110, by way of the thin client 160, of the identity of the client computer 130. For example, when a local application 135 starts and requests a document from a DMS or other published application 115, the software agent 150 intercepts the command, and passes it to the terminal server via the communication server 120. If the local application 135 attempts to access the DMS 170, the terminal server 110 or the communication server 120 may associate the identity of the client computer 130 with the identity of the local application 135. As a result, the terminal server 110 and communication server 120 may then form a common mapping for communications involving both session. For example, the communication server 120 may translate data it receives from the local application 135 into data that the terminal server 110 recognizes as being related to its session with the client computer 130, and vice versa.

As a result, according to some embodiments, the terminal server 110 may communicate with the thin client 160 to provide remote desktop services, enabling the thin client 160 to display a published application 115 as if it were running locally, while the communication server 120 and the software agent 150 may facilitate communications between local applications 135 and the DMS 170 or other published applications 115. With these communications, the data management system 100 may simulate local running of the published application 115. This simulation may, for example, enable communications between published and local applications 135 and 115 and enable both published and local applications 135 and 115 to access documents on a published DMS 170.

In one embodiment of the invention, a user at a client computer 130 may log into the terminal server 110 via the thin client 160, thus providing a terminal emulator on the client computer 130. Within the terminal emulator, the user may access one or more published applications 115, such as the DMS 170. For example, and without limitation, the user can open a published application 115 that is a word processor, such as Microsoft Word, and access one or more documents from the DMS 170, all within the terminal emulator provided by the thin client 160. To enable the user to work with these documents, the terminal server 110 may communicate with the thin client 160, which may communicate with the local operating system as needed to provide operating system access to the published word processor. The thin client 160 may be in communication with the terminal server 110 to display remote desktop on which the published word processor, or other published application 115, runs virtually. If the published word processor requires access to a local application 135, or vice versa, the software agent 150 may pass communications between the local application 135 and the published word processor, by way of the communication server 110.

Using these techniques, exemplary embodiments of the invention provide a system for facilitating interaction of a terminal emulator with a cloud-based data management system and a client-based application. This system comprises: (a) a first thin client 160 installed on a first client computer 130, the first thin client configured to establish and maintain a connection between the first client computer 130 and a terminal server 110 running first terminal services, thus acting as a terminal emulator; (b) a second thin client 160 installed on a second client computer 130, the second thin client configured to establish and maintain a connection between the second client computer 130 and the terminal server 110 running second terminal services, thus acting as a terminal emulator; (c) a first software agent 150 installed on the first client computer 130 in communication with a first local application 135, the first software agent 150 configured to establish and maintain a connection between the first client computer 130 and a communication server 120 running document management services, the document management services being disparate to the terminal services; (d) a second software agent 150 installed on the second client computer 130 in communication with a second local application 135, the second software agent 150 configured to establish and maintain a connection between the second client computer 130 and the communication server 120 running document management services, the document management services being disparate to the terminal services; (e) the terminal server 110 and the communication server 120 being disposed in mutual communication, the terminal server 110 and the communication server 120 maintaining a first mapping of the first terminal services to the first local application 135, the first mapping emulating co-location of the first terminal services and first local application 135 operating with disparate document management services; and (f) the terminal server 110 and the communication server 120 maintaining a second mapping of the second terminal services to the second local application 135, the second mapping emulating co-location of the second terminal services and second local application 135 operating with disparate document management services.

Below are several examples regarding the structure and operation of the data management system 100. These examples relate to particular embodiments of the invention and are provided for illustration. The examples below do not limit the various embodiments of the data management system 100, nor the appended claims.

### EXAMPLE 1

### Initiating Communications

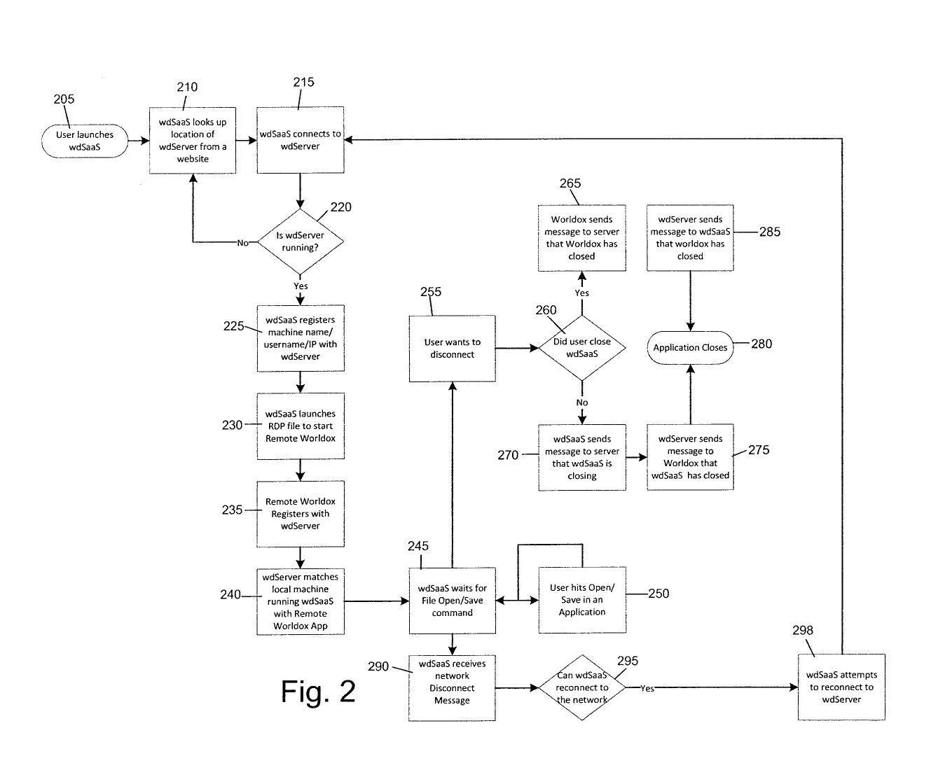

FIG. 2 is a flowchart of a process to initiate and maintain communication between a local software agent, a remote communication server, a remote DMS, and a local or published user application, according to some embodiments of the invention.

At 205, a user at a client computer 130 launches a software agent 150 (e.g. wdSaas), which looks up a location of a communication server 120, at 210, and attempts to connect to the communication server 120, at 215. If, at 220, the software agent 150 determines that the located communication server 120 is not running or is not available, then the software agent looks up an alternative communication server 120, at 210. This process continues until a connection with a running communication server 120 is established, or until the attempts to establish a connection fail (not shown), for example by interrogating all available servers, by adopting a time-out procedure, or by other methods.

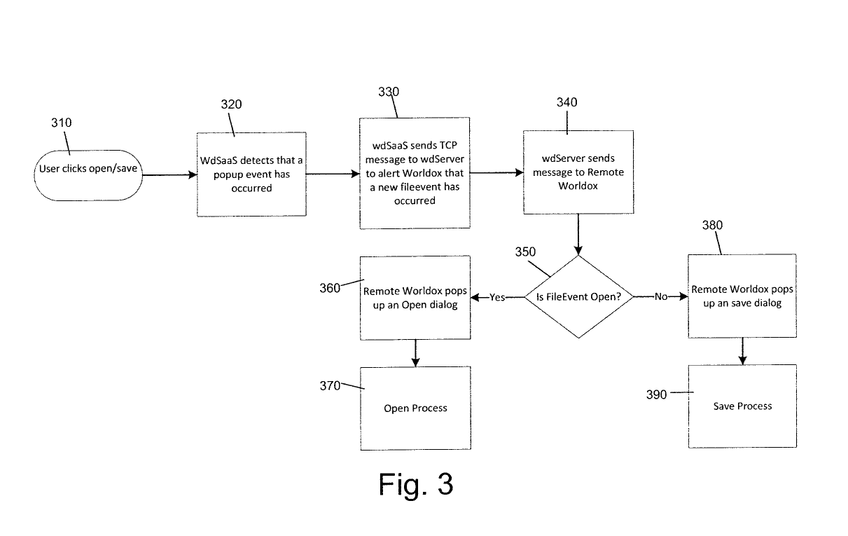

After the software agent 150 connects to a running communication server 120, the software agent 150 registers the client computer 130 with the communication server 120, at 225. At 230, the software agent 150 then launches a remote desktop protocol (RDP) from a thin client 160 (e.g., Remote Worldox, as shown in the figure) and connects to a terminal server 110. At 235, the thin client 160 registers with the communication server 120, by way of communications between the terminal server 110 and the communication server 120. At 240, the communication server 120 then matches the client computer 130 with the thin client 160, so as to keep their data coordinated and in synch. After the connections are made, at 245, the software agent 150 waits for a file open or save command, e.g. from a local application 135 or a published application 115, which is to be directed to a DMS 170 running on the terminal server 110. Such a command is made at 250, thus initiating a file open or save process, such as that illustrated in FIG. 3.

If the user wishes to disconnect from the cloud-based data management system 100, at 255, the thin client 160 determines whether the software agent 150 is still open, at 260. If the software agent 150 is closed, then the thin client 160 notifies the terminal server that the session has ended, at 265. Alternatively if the software agent 150 is still open, at 270, then the software agent 150 sends a message to the communication server 120 that the session is ending, and at 275, the communication server 120 notifies the terminal server 110 (which notifies the thin client 160) that the session is ending. At 280, the various relevant applications, such as the thin client or any published applications 115 in use, are closed. At 285, the communication server notifies the software agent 150 that the session has ended.

Alternatively, at 290, the software agent 150 may receive a network disconnect message from the communication server 120, e.g., if the connection is lost. In that case, the software agent attempts to reconnect to the communication server 120 at 290 and 298. If a reconnect is successful, then the cloud-based data management system 100 behaves as it does with an initial connection, at 215.

It will be appreciated that the file open and file save commands are examples, and various other commands may be processed in a similar manner. Similarly, a person of ordinary skill in the art will appreciate that the order of steps in the examples may be varied, in order to achieve similar results, or to achieve different results that are within the scope of the invention.

### EXAMPLE 2

### Initiating File Open or File Save

FIG. 3 is a flowchart showing initiation of a file open or save process using the remote DMS 170, according to some embodiments of the invention.

At 310, the user may opt to open or save a document, such as at 250 in FIG. 2. Selecting to open or save may initiate a pop-up or dialog, for example a pop-up or dialog that is native to an application, whether local or published, that is associated with a client computer 130. The software agent 150 detects this pop-up at 320. At 330, the software agent 150 sends a message to the communication server 120, on which runs a DMS 170 (e.g. Worldox), indicating that a new file event has occurred. At 340, the communication server 120 sends a message to the terminal server 110 that a new file event has occurred.

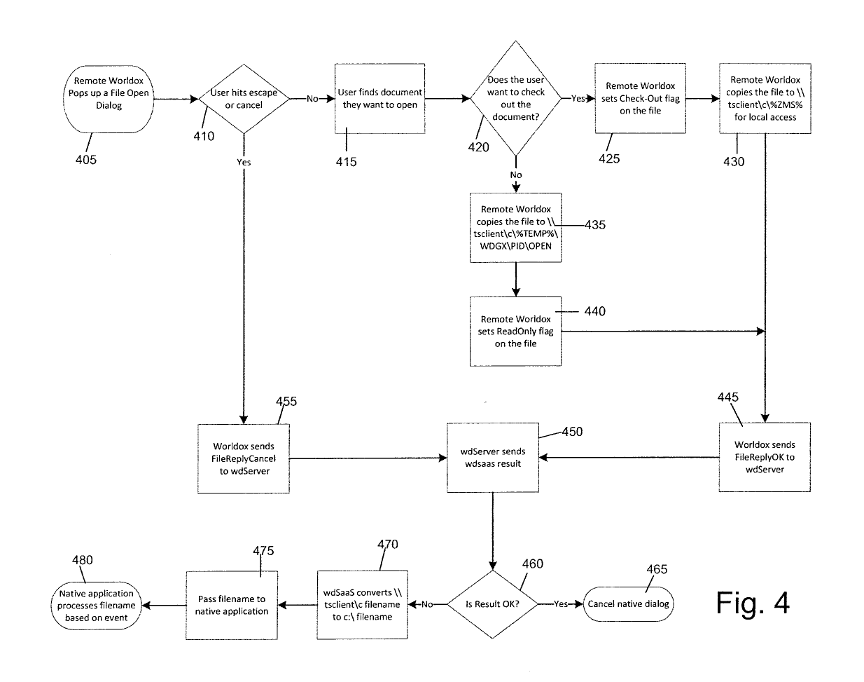

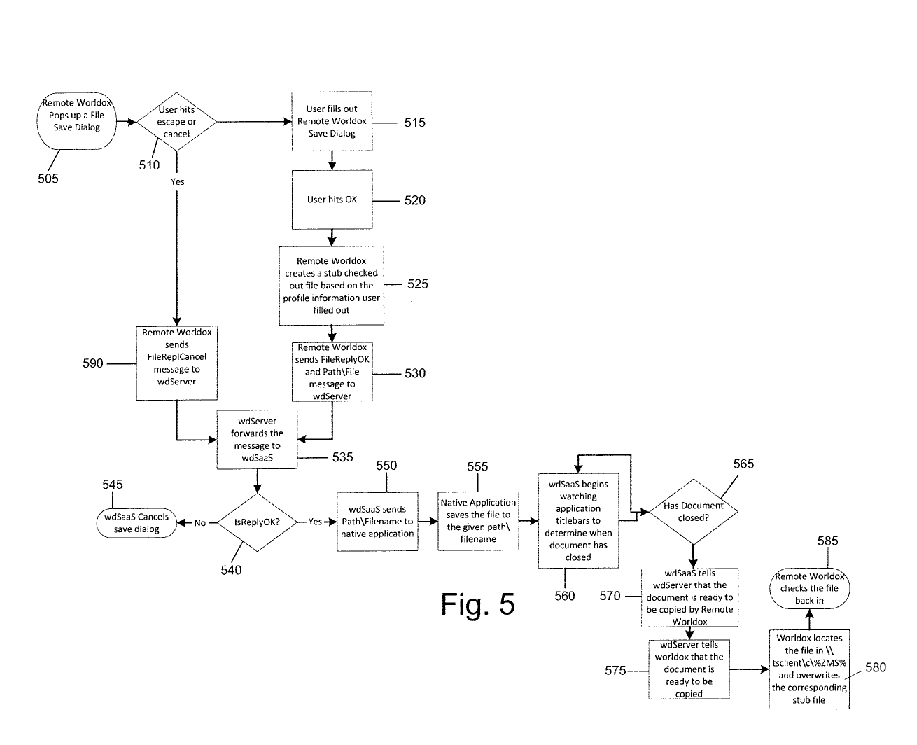

If, at 350, the file event is an open-file event, then the software agent 150, in cooperation with thin client 160, instructs the relevant published application 115, such as the DMS 170, to generate an open-file dialog, at 360, and an open-file process (FIG. 4) begins, at 370. If the file event is a file-save event, then the software agent 150 likewise interacts with the thin client 160 to generate a save-file dialog, at 380, and a save-file process (FIG. 5) begins, at 390. It will be understood that the FileEvent Open inquiry at 350 is illustrative, and the data management system 100 could test for a save command or various other commands. The dialog provided at 360 or 380 may be a different or enhanced dialog, associated with the published application 115 (e.g. the DMS 170), which replaces or supersedes a dialog associated with the dialog that is native to the application that initiated the command.

### EXAMPLE 3

### Opening a File

FIG. 4 is a flowchart of the file open process, according to some embodiments of the invention.

When the user opts to open a file in the DMS 170 (e.g. Remote Worldox), the software agent 150 generates an open-file dialog, at 405. If the user does not hit escape or cancel, at 410, then the user can locate the file he wishes to open via the dialog (with or without associated functions, e.g., search), at 415. After locating the file, the user can indicate whether he wants to open the file or check out the file, at 420. If the user opts to check out the file, then the DMS 170 sets the check-out flag on the file, at 425. The check-out flag may be used to invoke a function that locks the document to edits from other client computers 130 able to access the DMS 170. Otherwise, the document is opened without being checked out. This is a “behind-the scenes” check-out process to lock the document from changes, while file operations are in progress. At 430, the communication server 120 then transmits a copy of the file to the client computer 130 for local access. Alternatively, if the user desires access to the file without checking it out, at 420, the file is transferred to the client computer 130 without the check-out flag being set, at 435. Instead, a ReadOnly flag may be set at 440. After transferring the file, the DMS 170 informs the communication server 120 of the file transfer, at 445. Optionally the file may be copied to a different location, depending on whether it is checked out. If the user initiated an escape or cancel at 410, the DMS 170 would inform the communication server 120 of the cancellation, at 455. Regardless of whether the file open command was cancelled, or whether a file was checked out or opened, for read only or otherwise, the communication server 120 transmits to the software agent 150 a result of the open-file dialog, at 450.

At 460, the software agent determines whether the user's requested operation succeeded or failed. If the operation failed or was canceled, then the open-file dialog is canceled, at 465. If the open operation succeeded, then the software agent 150 renames the file as needed for handling by a local application 135, at 470, and passes the file to the local application 135 for handling, at 475. At 480, the local application 135 works with the file as per its normal operations.

### EXAMPLE 4

### Saving a File

FIG. 5 is a flowchart of the file save process, according to some embodiments of the invention.

In 505, a save as command (e.g., from a native application, such as a local copy of Microsoft Word) is intercepted by a DMS 170 (e.g. Remote Worldox) running as a published application 115. The DMS 170 substitutes its own save as dialog for the native dialog. If the save command was canceled or failed (as by an escape or cancel command at 510), then the save dialog is processed according to 590, 535, and 540 and the dialog closes, at 545. If the save command proceeds, the dialog is completed at 515, the save command is initiated at 520, and the published application 115 (e.g., DMS 170, or Remote Worldox) creates a copy of the saved file at 525 (which optionally could be a stub of the file), with the check-out flag set to yes—to allow, e.g., for local editing without overlapping changes to the document by others. Then, at 530, the published application 115 cooperates with the communication server 120 and the software agent 150 (e.g. WdSaas), to send path and filename information for the save command to the software agent 150. The software agent 150 renames the file as needed for handling by a local application 135, at 555, and passes the file to the local application 135 for handling, at 550.

At 560, the software agent 150 watches the local application 135 to determine when the file is closed. The thin client 160 may remain in a passive interface during this process. When the file is finally closed by the local application 135, at 565, the software agent 150 informs the communication server 120 that the file is ready to be copied to the DMS 170, at 570. At 575, the communication server 120 informs the DMS 170 that the file is ready to be copied. At 580, the DMS overwrites its version of the file with the current version, and at 585, the DMS 585 unsets the check out flag to indicate that the file is checked in. In this embodiment, the file is saved locally by the native application, under the control of the DMS 170 and software agent 150, until the file is closed. At that point, the saved file is copied to the cloud (i.e. to storage associated with the DMS 170) and the logs and database of the DMS are updated for the saved file. In other embodiments the file can be saved to the cloud periodically or each time the user enters a save command, regardless of whether the file is saved locally.

In some embodiments, as shown in FIGS. 2-5, the systems and methods of the invention may be implemented as part of or in coordination with the Worldox® DMS, from World Software Corp. This need not be the case, however, and various embodiments of the invention may use other software packages.

### EXAMPLE 5

### Integrated Published Application System

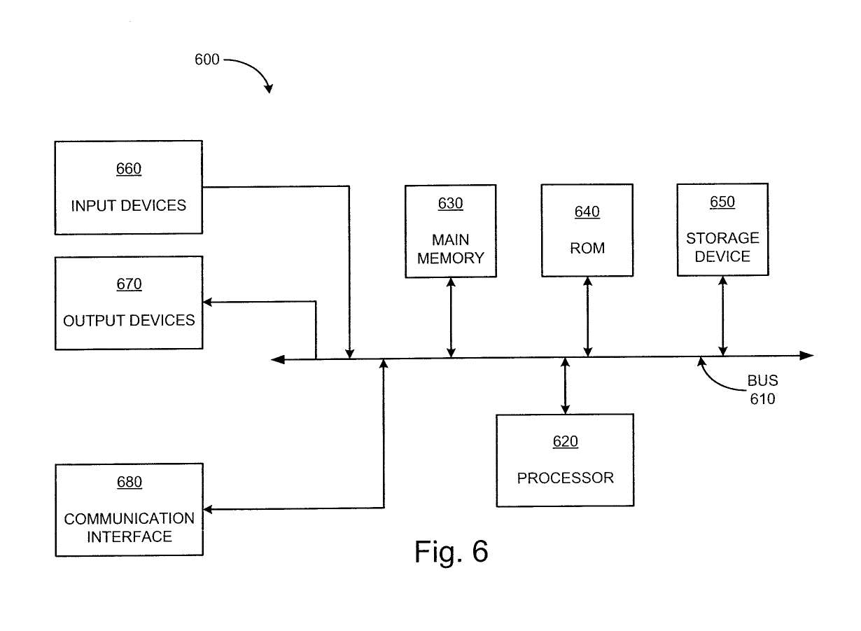

Various aspects of the invention may be embodied in one or more transitory or non-transitory computer-readable media for execution by a computer processor. FIG. 6 illustrates a computer system suitable for use with exemplary embodiments of the invention.

As shown, the computer system 600 may include a bus 610, a processor 620, a main memory 630, a read only memory (ROM) 640, a storage device 650, one or more input devices 660, one or more output devices 670, and a communication interface 680. The bus 610 may include one or more conductors that permit communication among the components of the computer system 600.

The processor 620 may be one or more conventional processors or microprocessors that interpret and execute instructions, such as instructions for providing aspects of the present data management system 100. The main memory 630 may include a random access memory (RAM) or another dynamic storage device that stores information and instructions for execution by the processor 620. The ROM 640 may include a conventional ROM device or another type of static storage device that stores static information or instructions for use by the processor 620. The storage device 650 may include a magnetic or optical recording medium and its corresponding drive.

The input devices 660 may include one or more mechanisms that permit an operator to input information to the computer system 600, such as a keyboard, a mouse, a pen, voice recognition, or biometric mechanisms. The output devices 670 may include one or more mechanisms that output information to an operator, including a display, a printer, or a speaker. The communication interface 680 may include any transceiver-like mechanism that enables the computer system 600 to communicate with remote devices or systems, such as a mobile device or other computing device 104 to which messages are delivered. For example, the communication interface 680 may include mechanisms for communicating over a network, such as the internet.

As discussed above, the computer system 600 may play a role in cloud-based data management. The computer system 600 may perform tasks to that end in response to the processor 620 executing software instructions contained in a computer-readable medium, such as memory 630. The software instructions may be read into memory 630 from another computer-readable medium, such as the data storage device 650, or from another device via the communication interface 680. Alternatively, or additionally, hardwired circuitry may be used in place of or in combination with software instructions to implement processes consistent with the disclosed technology. Thus, the data management system 100 is not limited to any specific combination of hardware circuitry and software.

While the making and using of various embodiments of the present invention are discussed in detail in this specification, it will be appreciated that the present invention provides many applicable inventive concepts which can be embodied in a wide variety of specific contexts. The specific embodiments discussed herein are merely illustrative of specific ways to make and use the invention, and do not delimit the scope of the present invention or the accompanying claims.

What is claimed is:

1. A system comprising:
a terminal server comprising one or more published applications accessible by the client computer and configured to provide remote desktop services to a client computer, the client computer being located remotely from the terminal server;
a communication server in communication with the terminal server;
a software agent executable on the client computer, the software agent being in communication with the communication server and configured to communicate with one or more of the published applications on behalf of the client computer; and
a thin client running on the client computer and associated with at least one published application on the terminal server, the thin client being configured to access the remote desktop services of the terminal server to furnish the first published application at the client computer.

2. The system of claim 1, wherein a published application comprises a document management system configured to support a plurality of documents stored remotely from the client computer.

3. The system of claim 1, wherein the thin client is configured to communicate with an operating system of the client computer as a local session of a corresponding published application on the terminal server.

4. The system of claim 1, wherein the thin client is configured to interact, on behalf of a first published application on the terminal server, with one of a local application running on the client computer and a second published application, on the terminal server, furnished to the client computer.

5. The system of claim 4, wherein the published applications comprise a document management system configured to support a plurality of documents stored remotely from the client computer.

6. The system of claim 5, the communication server being configured to:
receive a request from the software agent for a first document managed by the document management system;
retrieve the first document from the document management system; and
provide the first document to the client computer as direct by the software agent.

7. The system of claim 6, the software agent being configured to provide the first document to one of the local application and the second published application at the client computer.

8. The system of claim 7, wherein write access to the first document is blocked before providing the first document to the client computer.

9. The system of claim 3, wherein the software agent is configured to monitor a client computer for at least one action initiated by one of a local application and a first published application on the client computer, and to provide a response to the action as directed by a second published application.

10. The system of claim 9, wherein the second published application is a document management system, and the initiated action is a file open or file save command.

11. A system comprising:
a terminal server configured to provide remote desktop services to a client computer, the client computer being located remotely from the terminal server;
a communication server in communication with the terminal server;
a first application published at the communication server;
a thin client executable at the client computer and in communication with the terminal server and the communication server, wherein the terminal server populates the thin client with data related to the first application and provides remote desktop services to the thin client to furnish the first application at the client computer;
a document management system published at the terminal server and configured to manage a plurality of documents; and
a software agent executable on the client computer, the software agent being configured to deliver the plurality of documents to a local application running on the client computer.

12. The system of claim 11, the software agent being configured to initiate one or more prompts at the client computer before allowing the local application access to the plurality of documents.

13. The system of claim 11, the software agent being configured to request one or more of the plurality of documents from the document management system on behalf of the local application.

14. The system of claim 11, wherein the thin client is allowed the same access to an operating system of the client computer as is allowed to a corresponding local application.

15. The system of claim 14, wherein the thin client interacts with the operating system and the local application on behalf of the published application.

16. The system of claim 14, wherein the thin client interacts with the software agent and the published application to process one of an open file command and a save file command.

17. The system of claim 15, wherein the processed command is handled by a procedure initiated by the document management system.

18. The system of claim 17, wherein the procedure initiated by the document management system includes a non-native user interface that replaces a native user interface of the first published application.

19. The system of claim 18, wherein the non-native user interface comprises a dialog or popup that requests and receives data from a user.

20. The system of claim 19, wherein data received from the user is provided to the document management system.

21. A computer-implemented method of implementing publishing applications comprising:
running at least two published applications at a terminal server;
running remote desktop services on the terminal server in communication with each of a plurality of thin clients running locally on client computers that are remote from the terminal server, wherein each thin client represents an instance of at least one published application at the terminal server, and each thin client is in communication with a local operating system on the corresponding client computer;
installing a software agent on each client computer, wherein the software agent at each client computer is configured to communicate with the published applications on the terminal server and with the local thin client on the corresponding client computer;
invoking a first software agent, located at a first client computer, in response to a request by a first thin client corresponding to a first published application;
evaluating the request to determine if it is approved for transmission to at least one of the published applications;
sending an approved request to the terminal server for handling by a published application designated by the software agent;
processing the request to generate a response by at least the designated published application;
transmitting the response to the first software agent, and
providing the response to the first thin client on the first client computer.

22. The computer-implemented method of claim 21, wherein the designated published application is the first published application.

23. The computer-implemented method of claim 21, wherein the designated published application is a second published application.

24. The computer-implemented method of claim 23, wherein the second published application is a document management system.

25. The computer-implemented method of claim 23, wherein the request is one of a file open request and a file save request.

26. The computer-implemented method of claim 23, wherein the response by the second published application is an appropriate response to a request by the first published application.

27. The computer-implemented method of claim 21, further comprising:
providing a document management system on the terminal server, the document management system being configured to manage a plurality of documents; and
receiving a request from the first software agent for a local application at the first client computer to access a first document managed by the document management system.

28. The computer-implemented method of claim 21, further comprising providing to the software agent exclusive write access to the first document.

29. The computer-implemented method of claim 21, further comprising:
receiving an updated version of the first document from the software agent; and
storing the updated version of the first document to the document management system.

30. The computer-implemented method of claim 21, wherein the request is one of a file open request and a file save request.
